(19) United States
(12) Patent Application Publication
(10) Pub. No.: US 2002/0145948 A1
(43) Pub. Date: Oct. 10, 2002

(54) Disc and learning kit

(76) Inventor: Takashi Ando, Shizuoka (JP)

Correspondence Address: COOPER & DUNHAM LLP, 1185 Avenue of the Americas, New York, NY, 10036, US

(21) Appl. No.: 09/941,073

(22) Filed: Aug. 28, 2001

(30) Foreign Application Priority Data
Apr. 10, 2001 (JP) P2001-110824

(51) Int. Cl. G11B 11/00

(52) U.S. Cl. 369/13.56; 369/275.1

(57) ABSTRACT

An optical disc made by recording music on the disc in codes is placed on the rotor plate of the CD player, and the rotor plate is rotated by a hand. The codes are detected and decoded by a sensor substrate and a main circuit board to output tones having corresponding frequencies from a speaker. A plurality of unit code setting regions are formed on a surface of white color of the disc, and unit code regions selected at every unit code setting region are coated out in black color. And, white color and black color are respectively represent binary signals having logical values of “0” and “1” thereby combination and coding of the binary signals are performed.

### CROSS REFERENCE TO RELATED APPLICATIONS

This application claims priority to Japanese Patent Application JP 2001-110824, and the disclosure of that application is incorporated herein by reference to the extent permitted by law.

### BACKGROUND OF THE INVENTION

1. Field of the Invention

The present invention relates to an optical disc, a magnetic disc and a learning kit that is at least equipped with such discs, particularly to a learning kit using a compact disc player (hereinafter referred to as a “CD player”), and more specifically to a learning kit using a CD player for learning the fundamental principles of operation of the CD player.

2. Description of the Related Art

Thirty and several years ago, the CD player system was completed. The development of the CD player system is facilitated by introduction of a digitalizing method to audio techniques on the basis of computer techniques and advancement of semiconductor techniques, optical techniques and plastic techniques. At present, the CD player system has completely replaced the LP record player system.

Owing to a wide spread of CD players, an age group of music loving people has been expanded widely, and now even children in elementary school can enjoy music while freely operating CD players.

As an example, a phase-shift type optical disc is taken for the descriptions for a rewritable type optical disc, the recorded information of which can be rewritten as an optical disc to be used in a CD player. The phase-shift type optical disc performs recording and reproducing of information by utilizing the materials that reversibly change between a crystalline state such that the atomic arrangements of the materials are regular and an amorphous state such that the atomic arrangements of the materials are disordered by heat of a laser beam, e.g. Sn—Te—Se series materials, as a recording material for the optical disc.

In this case, at the time of recording of information, a strong laser beam pulse is irradiated for a short time on a recording material as to performing rapid heating of the recording material up to a melting point thereof or above, and rapid cooling of the recording material is performed for fixation of the recording material to the amorphous state thereof. At the time of erasing of the recorded information, the recording material is gradually heated up to the crystallizing temperature thereof or above, and then the recording material is gradually cooled for the returning of the recording material to the crystalline state thereof. The reproducing of the recorded information is performed by utilizing difference between the reflection coefficient in the crystalline state and the reflection coefficient in the amorphous state. In such way, the information is recorded on the optical disc in a state such that the information is coded into codes of binary numerals being combinations of binary signals, and the reproduction operation of the recorded information is performed by decoding such codes.

At the time of the reproduction operation of a CD player, the reproduction operation is performed by utilizing optical detection means composed of a laser diode and a photodiode. In this case, a laser beam for reproducing is irradiated on the recording material from the laser diode, and a detection signal being the codes of the combinations of binary numerals in correspondence with the recorded information, is output from the photodiode by detecting a difference between the reflection coefficient in the amorphous state when the information has been recorded and the reflection coefficient in the crystalline state when the information has not been recorded as two states, which are: a state in which the reflected light from the recording material exists and a state in which the reflected light does not exist.

Then, the decoding operation of the recorded information is performed by a decoding output circuit based on the detected signal, and a tone having a frequency corresponding to the recorded information is output from a speaker. Thus the reproduction operation is completed.

As described above, the recording and the reproduction operation of a CD player includes the coding for the conversion of recorded information of a tone to codes of combinations of binary numerals, decoding for decoding the coded information to the recorded information of the tone, principles of signal processing of digital signals in those processes, optical signal detection, and converting principles of an optical signal to an electric signal by photoelectric conversion. Those fundamental principles are common to the operation of various electronic apparatuses, and it is particularly important to make children in elementary school understand those fundamental principles and stimulate their interest in science, not to make them mechanically operate a CD player.

However, there are only a few text books that describe the aforesaid fundamental principles concerning a CD player in order that the children in elementary school can easily understand them. Nor any exhibition explaining the operation principles of a CD player for the children in elementary school are hardly held.

### SUMMARY OF THE INVENTION

The present invention has been conceived in consideration of the present situation of how information regarding the principle of a CD player is provided to children in elementary high schools or others. The present invention provides a disc for learning fundamental principles such as coding and decoding of information based on binary numerals, optical detection of recorded information, and digital signal processing. Moreover, the present invention provides a learning kit for learning fundamental principles, such as the coding and the decoding of information based on binary numerals, the optical detection of recorded information, and digital signal processing, and the configuration of a CD player.

A first embodiment of the present invention includes code setting regions where code information is set by selective coloring in correspondence with information to be recorded at prescribed portions of a disc, the code information being represented by coloring pattern in the code setting regions, that can be optically read.

A second embodiment of the present invention includes code setting regions where code information is set by selective coloring in correspondence with information to be recorded at prescribed portions of a disc, and the second embodiment at least comprises an optical disc from which the code information is represented by coloring pattern in the code setting regions, that can be optically read.

A third embodiment of the present invention includes code setting regions where code information is set by selective magnetization in correspondence with information to be recorded at prescribed portions of a disc, the code information being magnetically read according to the existence of the magnetization of the code setting regions.

A fourth embodiment of the present invention includes code setting regions where code information is set by selective magnetization in correspondence with information to be recorded at prescribed portions of a disc, and the fourth embodiment at least comprises a magnetic disc on which the code information is magnetically read according to the existence of the magnetization of the code setting regions.

Hereinafter, the present invention is described further in detail.

An optical disc according to an embodiment of the present invention is configured to have code setting regions, which are selectively colored according to information to be recorded, at prescribed portions on a disc (a substrate for making the optical disc) and to make it possible to optically read code information made by selective coloring to the code setting regions by a learner(an user) optically. Ordinary materials such as cardboard, a wooden board, a plastic board or the like may be utilized as a material for the disc, and paints, an oil-based ink, water colors or the like may be used for coloring. Further, musical scale information or the like may be alternatively used as the code information.

According to the aforesaid invention, the learner may make the code information by coloring the code setting regions selectively according to the information to be recorded, and the learner may learn that the code information may be represented by coloring pattern in the code setting regions.

Moreover, the learner may learn techniques for optical reading of such code information in the course of the optical reading of the code information by utilizing a sensor provided separately from the disc.

Furthermore, in an optical disc according to another embodiment of the present invention, code setting band sections, in which code setting regions are continuously formed along the circumferential direction of the disc, are divided by a predetermined range of angle around the center of a disc to be unitized. According to such embodiment of the present invention, the learner may learn how to make a code information appropriately in correspondence with information to be recorded on clearly divided code setting regions as if the learner performed drawing and handcrafting by selecting and coloring code setting regions B at the unitized region. The code setting regions B are divided by a prescribed angle range around the center of a disc to be formed in units in the rotation direction of the disc.

Furthermore, an optical disc according to another embodiment of the present invention is configured such that a plurality of code setting band sections are formed in concentric circles and a unit of the code information is formed from a combination of code setting regions arrayed in a radial direction. According to the embodiment of the present invention, a learner may learn how to make the code information representing a musical interval in correspondence with one unit composed of the code regions arrayed in radial direction among the plural code setting band sections formed in the concentric circles to the unit of information to be recorded, e.g. one musical interval, by performing selective coloring to each code region arranged in parallel. Further, the learner may learn that a number of code setting band sections and a number of code regions arrayed correspond to an amount of recorded information.

Furthermore, an optical disc according to still another embodiment of the present invention is configured such that the color of a disc surface is a light-reflecting color and code setting regions are selectively colored with a painting having another color that decreases the reflection of light on the disc surface so as to set the code information. According to the present invention, a learner may learn correspondence between the code information and the binary feature of a light-reflecting color and a light-absorbing color by selective coloring processing. In the selective coloring process, the code information is generated by painting the disc surface having the light-reflecting color with the color decreasing the light reflection on the disc surface.

Furthermore, in an optical disc according to another embodiment of the present invention, the color paint for decreasing the reflection coefficient on the disc surface is selected to be a black paint. According to the present embodiment, a learner may learn characteristics such that white color reflects light and black color does not reflect light by absorbing the light. Further, the learner may learn a fact that selective coloring of the black color and the white color heighten detection selectivity through making the code information under coloring condition of the black color and the white color while including the coloring that makes light be almost not reflected (by absorbing visible light) by selectively coloring the surface of the disc, of which is a light-reflecting color, with a paint of the black color that decreases the reflection of the light on the surface of the disc.

Furthermore, an optical disc according to a further embodiment of the present invention is configured such that the color of a surface of a disc is color decreasing the reflection of light and code setting regions are selectively colored with a paint of color having a reflection coefficient higher than that of the surface of the disc for making the code information. According to such embodiment, a learner may learn correspondence between the code information and the binary feature of a light-reflecting color by selective coloring processing and a light-absorbing color through the processes of making the code information. In the selectively coloring process of the disc surface, the color of the surface, of which is color decreasing the reflection of light, is painted with a paint of color having a reflection coefficient higher than that of the surface of the disc.

Furthermore, in an optical disc according to another embodiment of the present invention, a paint of color having a reflection coefficient higher than that of a surface of a disc is selected to be white color paint. According to the present embodiment, a learner may learn characteristics such that white color reflects light and black color does not reflect light by absorbing the light. Further, the learner may learn a fact that selective coloring of the black color and the white color heighten detection selectivity through making code information under coloring condition of the black color and the white color while including the coloring that makes light be almost totally reflected by selectively coloring the surface of the disc the color of the surface of which is color decreasing the reflection of light with a paint of the white color having a reflection coefficient higher than that of the surface of the disc.

Moreover, a learning kit according to an embodiment of the present invention has a structure equipped with at least an optical disc, wherein code setting regions that are selectively colored according to the information to be recorded are provided on prescribed portions of the disc, and the code information made by a learner's selective coloring is optically read. According to the present embodiment, the learner substantially learns an operation of a CD player during the processes such that the optical disc on which code information is formed is rotatably mounted on a bearing attached on the bottom plate of a housing of the CD player, and that the code information is optically read by a sensor attached to the top plate of the housing separately, and that tones of the frequencies in correspondence with scale codes are output from a speaker on a main circuit board attached separately to a side plate of the housing.

Moreover, in a learning kit according to another embodiment of the present invention, code setting regions of an optical disc are formed by unitization of code setting band sections formed continuously along a circumferential direction of a disc by the division of the code setting band sections at every prescribed angle around the center of the disc. According to the present embodiment, a learner may learn how to make the code information appropriately in correspondence with the information to be recorded to the clearly divided code setting regions by selecting and coloring the code setting regions, which are divided by the prescribed angle around the center of the optical disc and formed to be unitized along a rotational direction of the disc, at every unitized region.

Moreover, a learning kit according to another embodiment of the present invention is configured such that code setting band sections are made as a plurality of concentric circles, and that code information is made by a unit composed of code setting regions positioned in parallel to each other in a radial direction. According to the present embodiment, by performing the selective coloring of an optical disc at every code region arrayed in a radial direction in the code setting band sections, a plurality of which are formed in a state of concentric circles, as a unit, a learner may learn how to make the code information of a musical interval by setting of the unit as a unit of information to be recorded, e.g. one musical interval, correspondingly. Further, the learner may also learn that a number of the code setting band sections and a number of the parallel code regions correspond to an amount of recorded information.

Moreover, a learning kit according to another embodiment of the present invention is structured such that the color of a surface of a disc is a light-reflecting color, and that code setting regions are selectively colored with a paint of color decreasing the reflection light of the surface of the disc to make code information. According to the present embodiment, a learner may learn correspondence between the binary color of a light-reflecting color and a light-absorbing color by making the code information by performing selective coloring of the code setting regions of the disc, the color of the surface of which is a light-reflecting color, with a paint of color decreasing the reflection of the surface of the disc.

Furthermore, in a learning kit according to another embodiment of the present invention, the color paint for decreasing the reflection coefficient on a surface of a disc is selected to be black color paint. According to the present embodiment, a learner may learn characteristics such that white color reflects light and black color does not reflect light by absorbing the light. Further, the learner may learn a fact that selective coloring of the black color and the white color heighten detection selectivity through making the code information under coloring condition of the black color and the white color while including coloring that makes light almost not reflected by selectively coloring the code setting regions of the disc, the color of the surface of which is a light-reflecting color, with a paint of black color that decreases the reflection of the light on the surface of the disc.

Furthermore, a learning kit according to another embodiment of the present invention is configured such that the color of a surface of a disc is color decreasing the reflection of light and code setting regions are selectively colored with a paint of color having a reflection coefficient higher than that of the surface of the disc for making code information. According to the present embodiment, a learner may learn correspondence between the code information and the binary feature of a light-reflecting color and a light-absorbing color by selective coloring processing through the processes of making the code information by selectively coloring the code setting regions of the disc, the color of the surface of which is color decreasing the reflection of light, with a paint of color having a reflection coefficient higher than that of the surface of the disc.

Furthermore, in a learning kit according to another embodiment of the present invention, a paint of color having a reflection coefficient higher than that of a surface of a disc is selected to be white color paint. According to the present embodiment, a learner may learn characteristics such that white color reflects light and black color does not reflect light by absorbing the light. Further, the learner may learn a fact that selective coloring of the black color and the white color heightens detection selectivity through making the code information under coloring condition of the black color and the white color while including the coloring that makes light be almost totally reflected by selectively coloring the code setting regions of the disc, the color of the surface of which is color decreasing the reflection of light, with a paint of white color having a reflection coefficient higher than that of the surface of the disc.

Furthermore, in a learning kit according to another embodiment of the present invention, a removable housing is provided with a rotor plate for rotating an optical disc by placing the optical disc thereon, a sensor section for optically reading the code information of the optical disc, and an output section for outputting a sound signal on the basis of a detection signal from the sensor section. In this case, the rotor plate, the sensor section and the output section are removable from the housing by means of the concavity-convexity fitting thereof, the assembling thereof with machine screws, the affixing thereof with pressure sensitive adhesive tapes, or the like. According to the present embodiment, a learner can enjoy assembling the apparatus. And further, the learner can learn the basic structure of a CD player, the principle of decoding, and the principle of photoelectric conversion while directing the learner's curiosity to the following: an optical disc on which the code information has been made is rotatably set to a bearing fixed on the bottom plate of the housing; the code information is optically read by a sensor attached to the top plate of the housing separately; and tones having frequencies in correspondence with scale codes made as the code information are output from a speaker on the main circuit board additionally attached to a side plate of the housing.

Furthermore, in a learning kit according to another embodiment of the present invention, at least one of a top plate, a bottom plate and a side plate that constitute the housing is freely disassembled or assembled by means of the concavity-convexity fitting thereof, the assembling thereof with machine screws, the affixing thereof with pressure sensitive adhesive tapes, or the like. According to the present embodiment, a learner may learn the basic structure and the operation principle of a CD player in the process of assembling a study model of the CD player from the learning kit materials.

Furthermore, a magnetic disc according to another embodiment of the present invention is configured to have code setting regions, which are selectively magnetized according to information to be recorded, at prescribed portions on a disc and to make it possible to read the code information made by selective magnetization on the code setting regions by a learner magnetically. According to the present embodiment, the learner may make the code information by magnetizing the code setting regions selectively according to the information to be recorded, and the learner thereby learns how to make the code information in accordance with existence of magnetization. Moreover, the learner may learn techniques for magnetically reading of the code information made according to the existence of the magnetization in the processes of magnetic reading of the code information with a sensor provided separately from the disc.

Furthermore, in a magnetic disc according to another embodiment of the present invention, code setting band sections, in which code setting regions are continuously formed along the circumferential direction of a disc, are formed by their division by the predetermined angle around the center of the disc to be unitized. According to the present embodiment, a learner may learn the making of the code information appropriately correspondingly to the information to be recorded to the clearly divided code setting regions by selecting and magnetizing the code setting regions divided by the prescribed angle around the center of the disc to be formed in units in the rotation direction of the disc at every unitized region.

Furthermore, a magnetic disc according to another embodiment of the present invention is configured such that a plurality of code setting band sections are formed in concentric circles and the code information is formed by a unit composed of code setting regions arrayed in a radial direction. According to the present embodiment, a learner may learn how to make the code information of a musical interval by performing selective magnetization of each code region arranged in parallel. Here, one unit composed of code setting regions arrayed in a radial direction among the plural code setting band sections formed in the concentric circles corresponds to the unit of information to be recorded, e.g. one musical interval. Further, the learner may learn the correspondence of a number of the code setting band sections and a number of the code regions arrayed to an amount of recorded information.

Furthermore, a magnetic disc according to another embodiment of the present invention is configured such that a disc surface is formed with a non-magnetic material, and that code setting regions are selectively magnetized with a magnetic material in order to make the code information. According to the present embodiment, a learner may learn binary magnetic information based on non-magnetization and magnetization composing the code information by selectively magnetizing the code setting regions of a disc, a surface of which is formed with a non-magnetic material, with a magnetic material.

Furthermore, a magnetic disc according to another embodiment of the present invention is configured such that code information is made by selectively affixing magnetic sheet in code setting regions. According to the present embodiment, a learner may learn how to make the code information on a magnetic disc by selective affixing the magnetic sheet to the code setting regions.

Moreover, a learning kit according to an embodiment of the present invention has a structure equipped with at least a magnetic disc that is configured such that code setting regions that are selectively magnetized according to the information to be recorded are provided on prescribed portions of a disc, and that the code information made by learner's selective magnetization is magnetically read. According to the present embodiment, the learner substantially learns operation of a CD player in the following processes. That is, a magnetic disc, on which the code information is formed, is rotatably mounted on a bearing attached on the bottom plate of the housing of the CD player, and the code information is magnetically read by a sensor additionally attached to the top plate of the housing, and tones of the frequencies in correspondence with scale codes made as the code information are output from a speaker on a main circuit board additionally attached to a side plate of the housing.

Moreover, in a learning kit according to another embodiment of the present invention, code setting regions on a magnetic disc are formed by unitization of code setting band sections. The code setting band sections are formed continuously along a circumferential direction of a disc by dividing the code setting band sections at every prescribed angle around the center of the disc. According to the present embodiment, a learner may learn how to make the code information appropriately in correspondence with the information to be recorded to clearly divided code setting regions by selecting and magnetizing the code setting regions. The code setting regions are divided by the prescribed angle around the center of the optical disc so as to be unitized.

Moreover, a learning kit according to another embodiment of the present invention is configured such that code setting band sections are formed as a plurality of concentric circles, and that the code information is made by a unit composed of code setting regions positioned in parallel to each other in a radial direction. According to the present embodiment, by performing the selective magnetization of a magnetic disc at every code region arrayed in a radial direction in the code setting band sections, a plurality of which are formed as concentric circles, as a unit, a learner may learn how to make the code information of a musical interval by the setting of the unit as a unit of information to be recorded, e.g. one musical interval, correspondingly. Further, the learner may learn that a number of the code setting band sections and a number of the parallel code regions correspond to an amount of recorded information.

Moreover, a learning kit according to another embodiment of the present invention is structured such that a surface of a disc is formed with a non-magnetic material, and the code information is made by selectively magnetizing of code setting regions. According to the present embodiment, a learner may learn how to make non-magnetization and magnetization correspond to binary magnetic information. The code information is made by performing the selective magnetization of the code setting regions on a surface, which is made of a non-magnetic material, of a disc.

Furthermore, a learning kit according to an embodiment of the present invention is configured such that code information is made by the selective affixing of a magnetic sheet in a unit code setting region. According to the present embodiment, a learner may learn how to make the code information on a magnetic disc by the selective affixing of the magnetic sheet in the unit code setting region.

Furthermore, in a learning kit according to an embodiment of the present invention, a removable housing is provided with a rotor plate for rotating a magnetic disc in a state of placing the magnetic disc thereon, a sensor section for reading the code information of the magnetic disc magnetically, and an output section for outputting a sound signal on the basis of a detection signal from the sensor section. In this case, the rotor plate, the sensor section and the output section are removable from the housing by means of the concavity-convexity fitting thereof, the assembling thereof with machine screws, the affixing thereof with pressure sensitive adhesive tapes, or the like. According to the present embodiment, a learner may learn the basic structure of a CD player, the principle of decoding, and the principle of magneto-electric conversion in addition to issues to be learnt in the following processes: a rotatable magnetic disc on which code information has been made is mounted on a bearing fixed on a bottom plate of a housing; the code information is magnetically read by a sensor additionally attached to a top plate of the housing; and tones having frequencies in correspondence with scale codes made as the code information are outputted from a speaker on a main circuit board additionally attached to a side plate of the housing.

Furthermore, in a learning kit according to another embodiment of the present invention, at least one among a top plate, a bottom plate and side plates that constitute the housing is freely disassembled or assembled by means of a concavity-convexity fitting thereof, the assembling thereof with machine screws, the affixing thereof with pressure sensitive adhesive tapes, or the like. According to the present embodiment, a learner may learn the basic structure and the operation principle of a CD player in the process of assembling an educational model of the CD player from the learning kit materials.

### BRIEF DESCRIPTION OF THE DRAWINGS

The foregoing and other objects, features and advantages of the present invention will be apparent to those skilled in the art from the following description of the preferred exemplary preferred embodiments of the present invention taken in conjunction with the accompanying drawings, in which:

FIG. 1 is a plan view of a disc for making an optical disc according to a first embodiment of the present invention, and shows a surface on which a code setting region is formed;

FIG. 2a and FIG. 2b are explanatory diagrams showing the gist for making an optical disc by the use of the disc of FIG. 1 (the gist of information recording) in the case in which code information is set by the coding of a heptachord in accordance with the existence of coloring in a unit code setting region of the disc;

FIG. 3 is a plan view of an optical disc made by the use of the disc of FIG. 1;

FIG. 4 is an explanatory diagram showing the gist of making an optical disc according to Example 1 of the present invention;

FIG. 5 is a plan view of an optical disc made by Example 1;

FIG. 6 is a perspective view showing the whole structure of a learning kit that is a reproducing apparatus for outputting a sound signal by reading the code information of an optical disc optically according to Example 2 of the present invention;

FIG. 7a is a perspective view showing the attachment state of a rotor plate constituting the reproducing apparatus of FIG. 6, and

FIG. 7b is a front view showing a part of FIG. 7a;

FIG. 8a to FIG. 8c are diagrams related to the gist of the attachment of a sensor substrate constituting the reproducing apparatus of FIG. 6, in which

FIG. 8a is a perspective view showing the gist of the attachment of the sensor substrate to the bottom end face of a spacer, and in which

FIG. 8b is a top view of a spacer illustrating the gist of setting the spacer after being attached to the sensor substrate in the housing of the reproducing apparatus by the fixation of the spacer on the inner surface of the top plate constituting the housing, and in which

FIG. 8c is a plan view showing the spacer fixed on the inner surface of the top plate in conformity with the gist of FIG. 8b when the spacer is viewed from the upside of the housing; and

FIG. 9a to FIG. 9b are electric circuit diagrams related to the reproducing apparatus of FIG. 6, in which

FIG. 9a is the electric circuit diagram of the sensor substrate shown in FIG. 8a to FIG. 8c, and in which

FIG. 9b is the electric circuit diagram of the main circuit board shown in FIG. 6.

### DESCRIPTION OF THE PREFERRED EMBODIMENTS

Next, the embodiments of the present invention are described on the basis of the attached drawings.

First Preferred Embodiment

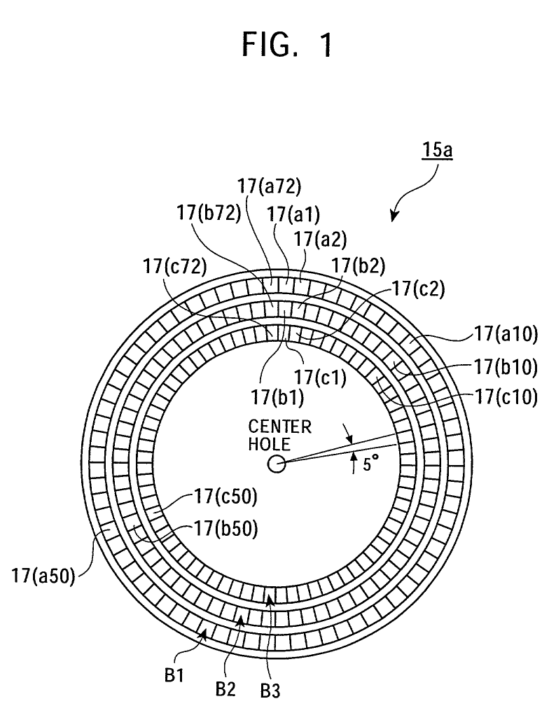

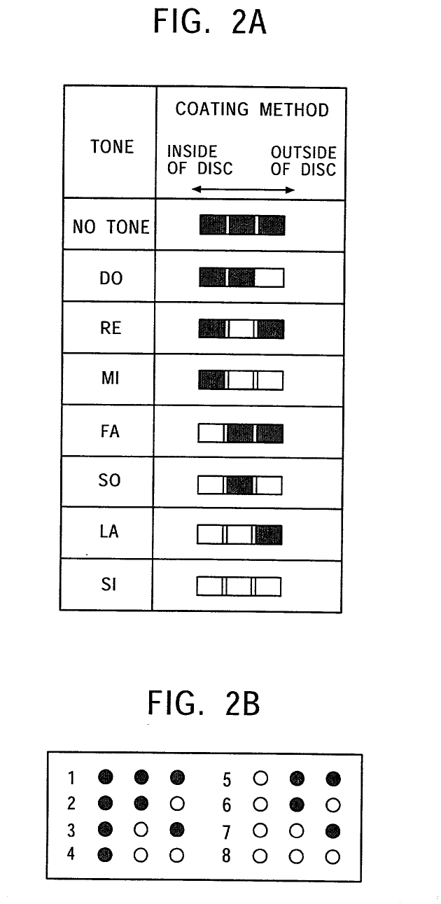

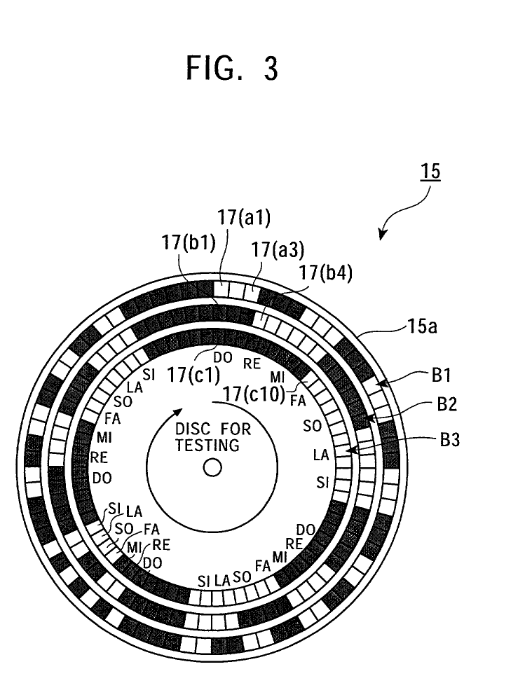

FIG. 1 is a plan view showing a surface of a disc 15a that is a substrate (in a shape of a disc) for making of an optical disc on the side on which code information is formed (code information writing side). FIG. 2a and FIG. 2b are explanatory diagrams of a method for making a read-only optical disc 15 by the use of the disc 15a (information writing method). That is, FIG. 2a and FIG. 2b are explanatory diagrams in the case in which the code information is made by the coding of a heptachord in accordance with existence or non-existence of the coloring of a unit code setting region (that will be described later) of the disc. FIG. 3 is a plan view of the optical disc 15 made by the use of the disc 15a of FIG. 1. Incidentally, in the present embodiment, the code setting regions are formed on one side of the disc, but it is also possible to form the code setting regions on both surfaces of the disc.

In the case in which the optical disc 15 shown in FIG. 3 is made, as shown in FIG. 1, circular code setting band sections B1, B2 and B3 are formed on the disc 15a made of thick paper, a plastic sheet, a metal plate or the like, and unit code regions 17(a1)-17(a72), unit code regions 17(b1)-17(b72) and unit code regions 17(c1)-17(c72) are respectively formed divided in the code setting band section B1, the code setting band section B2 and the code setting band section B3 by the equal division of the code setting band sections B1, B2 and B3 along the clockwise circumferential direction by the central angle of 5° of the disc.

In this case, for example, in the unit code regions 17(a1), 17(b1) and 17(c1), the boundary lines on the right and the left sides of those regions are lines divided by the prescribed angle around the center of the disc. Moreover, the aforesaid three unit code regions 17(a1), 17(b1) and 17(c1) are formed in parallel with each other in a radial direction of the disc on a plurality of concentric circles, and the aforesaid three unit code regions 17(a1), 17(b1) and 17(c1) constitute a first unit code setting region in a group. The other unit code regions 17(a2), 17(b2) and 17(c2) to 17(a72), 17(b72) and 17(c72) are the same, and the unit code regions 17(a5), 17(b5) and 17(c5) constitute a fifth unit code setting region, and then the unit code regions 17(a72), 17(b72) and 17(c72) constitute a seventy-second unit code setting region.

Further, each of the first to the seventy-second unit code setting regions forms a code setting region for recording the code information of a binary signal. Each of the unit code setting regions is configured in accordance with the tone of each frequency of a scale. In each code setting region, white color and black color correspond to the logical value “0” and the logical value “1” of a binary signal, respectively. At the time of the coding, the aforesaid first to the seventy-second unit code setting regions are coded by eight kinds of coding of tones of “do”, “re”, “mi”, “fa”m “sol”, “la” and “si” of the heptachord and “no tone” as shown in FIG. 2a and FIG. 2b. The coding is performed by the selection of a binary value by the setting of white color or the setting of black color in each of the three unit code regions of each unit code setting region. Because the reflection coefficient of light greatly differs according to whether the code setting region is white color or black color, the optical detection of the intensity of the reflected light that has been irradiated on those code setting regions enables the read out of the aforesaid tone information.

When the aforesaid optical disc 15 is compared with an optical disc (CD, LD or the like) now on the market, the disc 15a constituting the former corresponds to a plastic substrate (in a state in which no information pit are formed) in the latter, and the sections coded by the coloring with the black color and the white color of the code setting regions constituting the former correspond to the information pits in the latter.

As an apparatus for reading the tone information recorded on an optical disc, an apparatus is available that is equipped with a rotor plate for rotating the optical disc (or a rotary table for rotating an optical disc, e.g. placed thereon, in a horizontal direction), a sensor section for optically detecting the code information of the optical disc, and an output section for outputting a sound signal on the basis of a detection signal from the sensor section. In this case, as the aforesaid sensor section, a sensor section is adopted that is equipped with a light emitting section for irradiating light on a code setting region of the rotating optical disc and a light receiving section for receiving the reflected light from a code setting region. However, as the aforesaid output section, an apparatus that outputs an image such as a character on an appropriate display in place of the sound signals or together with them may be alternatively adopted. In this case, the image signal is set to be read owing to the aforesaid code information.

When the whole surface of one side of the disc 15a is the white color in the case in which code setting regions are formed on the one side of the disc 15a, tone information is recorded by the selective coloring of the black color to the code setting regions. Moreover, in contrast with the aforesaid case, when the whole surface of one side of the disc 15a is the black color in the case in which code setting regions are formed on the one side of the disc 15a, tone information is recorded by the selective coloring of the white color to the code setting regions. Incidentally, the usage of the white color and the black color is only an example. When the precision of a pickup is high, not only the white color but also a light-reflecting color slightly, e.g. gray color, may be used. On the other hand, when a pickup that does not require such a high precision is adopted, not only the black color but also color decreasing slightly the reflection of light, e.g. dark gray color, may be used. Moreover, when the whole surface of one side of the disc 15a is, for example, a gray color or colorless and transparent in the case in which code setting regions are formed on the one side of the disc 15a, tone information is recorded by the selective coloring of the code setting regions with the black color and the white color. The situations are the same in the case in which tone information is recorded on both the surfaces of the disc 15a.

It is very desirable to make the coloring with the black color and the white color a pure black color and a pure white color, respectively. The reason is that, because the difference of light reflection coefficient between these colors is very large, the reading of code information can be performed with high accuracy, and that precise reading can be performed with a not so precise reading apparatus. However, the coloring of the present invention is not limited to the using of the black color and the white color, but it is enough in short for the coloring to be performed by means of two colors (or two kinds of materials) having enough difference in reflection coefficient between each other, the reflection coefficient of one being higher than a prescribed value previously set and the reflection coefficient of the other being lower than the prescribed value.

For example, in the case in which the surface of a disc is color or a material, the reflection coefficient which is high, a paint of color or a material the reflection coefficient which is lower than that of the disc surface is coated on the surface, or a film, a sheet, or a plate material the surface of which is formed with such color or a material is affixed on the code setting regions of the surface of the disc. Moreover, in contrast, in the case in which the surface of a disc is color or a material the reflection coefficient is low, it is allowable that a paint of color or a material the reflection coefficient which is higher than that of the disc surface is coated on the surface, or that a film, a sheet, or a plate material the surface of which is formed with such color or a material is affixed on the code setting regions of the surface of the disc. Incidentally, in the case in which a disc made of a material having high transparency such as glass and transparent plastic, it is enough to coat two kinds of paints the reflection coefficient of which differs from each other in largeness or to affix two kinds of films, sheets or plate materials the reflection coefficient of which differs from each other in largeness. Moreover, it is also possible to erase the aforesaid tone information by the peeling of the affixed film or the like, or the overcoating of colored portions with white color.

Furthermore, binary signals may also be recorded as follows. That is, although each code setting region (in the whole area) is selectively painted out in black and white, for example, marks such as black circles with a thick line or black circles coated out in black, appropriate characters, patterns or figures maybe used as notes in place of the coating out in black in the whole area.

Incidentally, when the code information of an optical disc on both the surfaces of which the code information is recorded is read (reproduced), two methods are available. One of the methods is to read the code information by the provision of one reading apparatus and by the setting of one side of the optical disc to be opposed to the reading apparatus. The other method is to read the code information by the provision of two reading apparatus opposed to each other and by the provision of the optical disc between the reading apparatus in such a way that one surface of the optical disc is opposed to one of the reading apparatus and the other surface of the optical apparatus is opposed to the other reading apparatus.

Second Preferred Embodiment

Although sound signals constituted of binary signals are recorded on a disc surface by the color-coding of unit code setting regions on the surface with, for example, black color and white color in the aforesaid first embodiment, the present invention is not limited to such a method. For example, sound signals constituted of three value signals (ternary numbers) can also be recorded by the color-coding using white color, gray color, and black color. For example, in the case in which the aforesaid three valued signals are recorded in the unit code setting regions on the disc surface shown in FIG. 1, it is possible to record 3×3×3=27 ways of sound signals. Furthermore, for example, in the case in which four valued signals (quaternary numbers) are recorded in unit code setting regions after the alteration of the structure shown in FIG. 1 to form four code setting band sections, 4×4×4×4=256 ways of sound signals can be recorded.

Third Preferred Embodiment

Although the reproducing apparatus for reading and outputting the code information of an optical disc in the aforesaid embodiments receive the reflected light from code setting regions, the present invention is not limited to such a structure. It is possible to adopt a reproducing apparatus which is equipped with a light receiving section for receiving the transmitted light of the light irradiated to a code setting region as a sensor section for optically detecting code information of an optical disc, and which reproducing apparatus measures the intensity of the transmitted light to output the code information. However, in this case, it is necessary to use a disc made from a material having high transparency (a glass plate, or a sheet or a plate made of transparent plastic) and divide the transparency of code setting regions to be high or low.

Fourth Preferred Embodiment

According to the present invention, a learning kit can be constituted by use of the aforesaid various discs (substrates for recording code information) or the aforesaid various optical discs (that have recorded code information thereon). In particular, the learning kit provides to a learner, e.g. an elementary or a junior high school student, means for solving the following by distributing the aforesaid disc and a kit for constructing the aforesaid reproducing apparatus circuit for having the learner to make an optical disc of a prescribed structure, the construction of a reproducing apparatus, and reproduction operations:

(1) the fundamentals of electric and electronic circuits;

(2) the fundamental knowledge of electronic components;

(3) the meaning of digital and a digital signal;

(4) the meaning of binary numerals and the principle of coding and decoding;

(5) the fundamental structures and the operation of a CD and a CD player; and

(6) the principle of photoelectric conversion.

Fifth Preferred Embodiment

Although the aforesaid embodiments concern optical discs and reproducing apparatuses that optically reproduce the information recorded on optical discs, the present invention can constitute a magnetic disc and a reproducing apparatus that magnetically reproduce magnetic information (the information recorded by magnetization) recorded on the disc.

The aforesaid optical disc has code setting regions on prescribed portions of a disc in a prescribed form, and has digital signals recorded based on differences in reflection coefficient of light on the code setting regions. On the other hand, the aforesaid magnetic disc (1) records digital signals based on the existence of magnetic properties in code setting regions, or (2) records digital signals based on the amount of magnetization (the intensity of magnetization) of a magnetic material provided for the code setting regions, or (3) records digital signals based on the difference of direction of magnetization of the magnetic material provided in the code setting regions. The other structures of the magnetic disc are the same as those of the aforesaid optical disc. However, it is necessary for the magnetic disc to make a disc being a substrate with a non-magnetic material [paper, glass, plastics or metal materials (e.g. aluminum) except for ferromagnetic metals such as iron, nickel or the like]. However, the following items do not matter: the transparency of the disc, the existence of coloring of the disc, and the kinds of colors of the coloring.

For example, the magnetic disc of the aforesaid item (1) can be made by coating through a paint made from magnetic material on (the whole surface or portions of the surfaces of) appropriate unit code regions constituting unit code setting regions on a surface of a disc and by magnetization of the coating by the use of appropriate means, or by the affixing of fragments of a magnetic tape (or a magnetic sheet) after the processing of magnetization to appropriate unit code regions.

Furthermore, the aforesaid magnetic disc of the item (3) can be made as follows. An aluminum disc and a magnetic tape (or a magnetic sheet) are prepared. The magnetic tape is processed by magnetization processing. In this case, the magnetization is performed in a direction orthogonal to the longer direction of the tape. The tape is cut in parallel with the aforesaid magnetization direction to be slightly smaller than each of the unit code regions, and many magnetized fragments, the magnetization direction of which differs in opposite directions, are thereby prepared. A magnetic disc having the same functions as those of a magnetic disc which constitutes a hard disc and information been recorded on can be made by the affixing of those magnetized cut fragments to appropriate unit code regions.

As a reproducing apparatus for reading code information such as tone information recorded on the aforesaid various magnetic discs, a reproducing apparatus can be used that is equipped with a rotor plate for rotating a magnetic disc, a magnetically sensitive semiconductor device (such as Hall device) in a known structure as a sensor section for magnetically detecting code information of the magnetic disc, and an output section for outputting a sound signal or the like on the basis of a detection signal from the magnetism-sensitive semiconductor device.

Sixth Preferred Embodiment

According to the present invention, a learning kit can be constituted by use of the aforesaid materials for making a magnetic disc or a magnetic disc made by such materials. In particular, the learning kit provides to a learner, e.g. an elementary or a junior high school student, means for learning the following by distributing the aforesaid materials for making a magnetic disc and a kit for assembling the aforesaid reproducing apparatus circuit for having the learner to make a magnetic disc of a prescribed structure, the construction of a reproducing apparatus, and reproduction operations:

(1) the fundamentals of electric and electronic circuits;

(2) the fundamental knowledge of electronic components;

(3) the meaning of digital and a digital signal;

(4) the meaning of binary numerals and the principle of coding and decoding;

(5) the fundamental structures and the operation of a CD and a CD player; and

(6) the principle of the conversion of magnetic data to electric data.

Furthermore, a learner can efficiently learn by experimentation by the adoption of the construction of a reproducing apparatus in which a rotor plate, a magnetic sensor section and a sound signal output section, which are all the components of the reproducing apparatus, are removably attached to the housing thereof, or by the adoption of the construction of the housing such that all of or parts of the top plate thereof, the bottom plate thereof, and the side plates thereof can freely be disassembled or assembled.

### EXAMPLE

Next, examples of the embodiments according to the present invention are described.

### Example 1

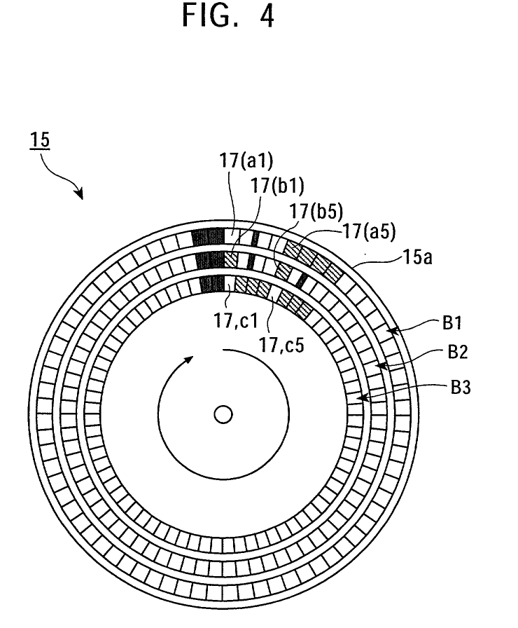

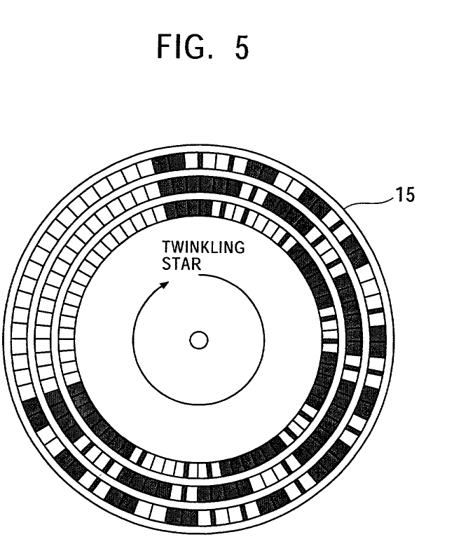

A description is provided for learning operation done by a learner of recording music on a new disc by a learner. FIG. 4 is an explanatory diagram showing the gist of making an optical disc 15, and FIG. 5 is a plan view of the optical disc 15 so made. The optical disc 15 is made by the use of the disc 15a shown in FIG. 1.

The unit code regions of the code setting band sections B1, B2 and B3 of the disc 15a that is shown in FIG. 4 and is made of paper in white color are all in the original white color before learning of the operation of recording music. While a learner is looking at a score of the music of “Chouchou (butterfly)” that the learner wants to record, the learner picks out sounds in correspondence with the scales of the music in sequence. The learner recodes the “sol tone” in code in a first unit code setting region consisting of unit code regions 17(a1), 17(b1) and 17(c1) by painting out the unit code region 17(b1) in black with an aqueous fiber-tipped pen, and the learner recodes “mi tone” in code in a second unit code setting region consisting of unit code regions 17(a2), 17(b2) and 17(c2) by painting out the unit code region 17(c2) in black with the aqueous fiber-tipped pen.

As shown in the figure, although the “mi tone” is also recoded in code in a third unit code setting region anda fourth unit code setting region, a short interval where there is no tone is formed between the second unit code setting region and the third unit code setting region for the prevention of the music from being heard strangely owing to being a continuous tone. FIG. 4 shows the processes of coded recording up to an eighth unit code setting region. A “fa tone”, a “re tone”, a “re tone” and a “re tone” are respectively recoded in codes in a fifth unit code setting region to the eighth unit code setting region. A short toneless interval is formed between a sixth unit code setting region and a seventh unit code setting region.

The method of coding is described further in detail. The code setting band sections B1, B2 and B3 are formed on the outer periphery edge side of the disc 15a in concentric circular ring state, and these code setting band sections B1, B2 and B3 are equally divided into a plurality of unit code regions (360°+5°=72) in the circumferential direction by the unit angle of 5° around the center of the disc 15a. That is, the code setting band section B1 are divided into the unit code regions 17(a1)-17(a72), and the code setting band section B2 is divided into the unit code regions 17(b1) -17(b72), and further the code setting band section B3 is divided into the unit code regions 17(c1)-17(c72).

And, unit code regions, positioned on the same radial direction, of the code setting band sections B1-B3 are set as a unit code setting region, and coding in correspondence with a scale frequency with white color and black color is performed at every unit code setting region. The gist of the coding has already described by reference to FIG. 2a and FIG. 2b.

In such a way, the learner selects a necessary unit code region of the unit code regions 17(a1)-17(a72), 17(b1)-17(b72) and 17(c1)-17(c72) of the code setting band sections B1, B2 and B3 of the disc 15a by reference to the music, and the learner coats out the selected unit code regions in the black color. And thereby the music of “Chouchou” is coded and recorded on the disc 15a.

### Example 2

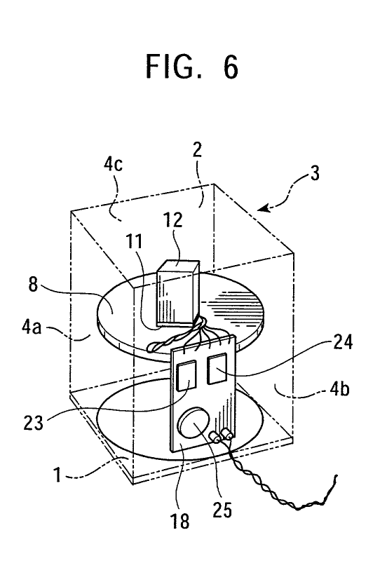

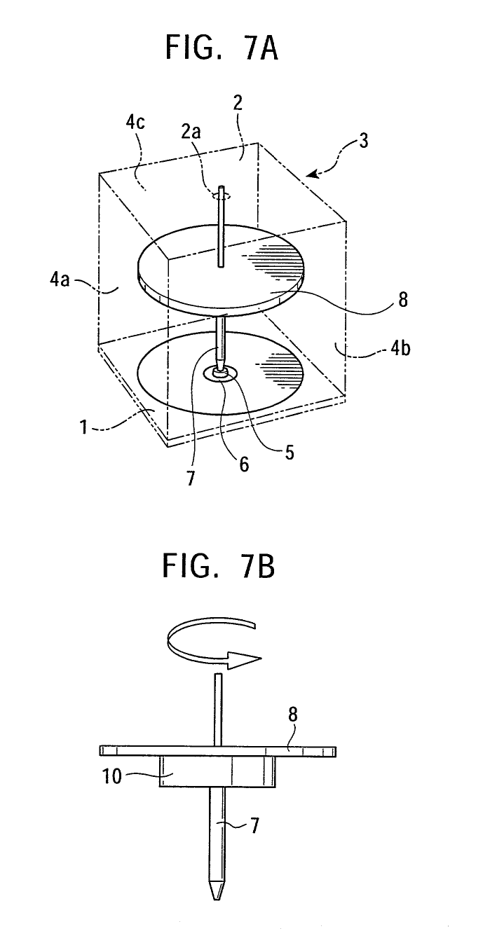

The present Example concerns a learning kit composed of the optical disc shown in FIG. 5 and a reproducing apparatus to be shown in FIGS. 6-9b. FIG. 6 is a perspective view showing the whole structure of the reproducing apparatus that optically reads the code information of an optical disc to output a sound signal. FIG. 7a is a perspective view showing the attachment of a rotor plate 8 constituting the reproducing apparatus of FIG. 6. FIG. 7b is a front view showing a part of FIG. 7a.

On the optical disc 15 shown in FIG. 5, the tones of the music of “Kirakira Boshi (twinkling star)” are coded and recorded in each unit code setting region as combination codes of binary signals in black and white. When the optical disc 15 is placed on the rotor plate 8 of the reproducing apparatus shown in FIG. 6 and is rotated counterclockwise, a sensor substrate 11 detects codes in sequence, and then the music of “Kirakira Boshi” is output from a speaker 25 on a main circuit board 18. This operation is described in detail in the following.

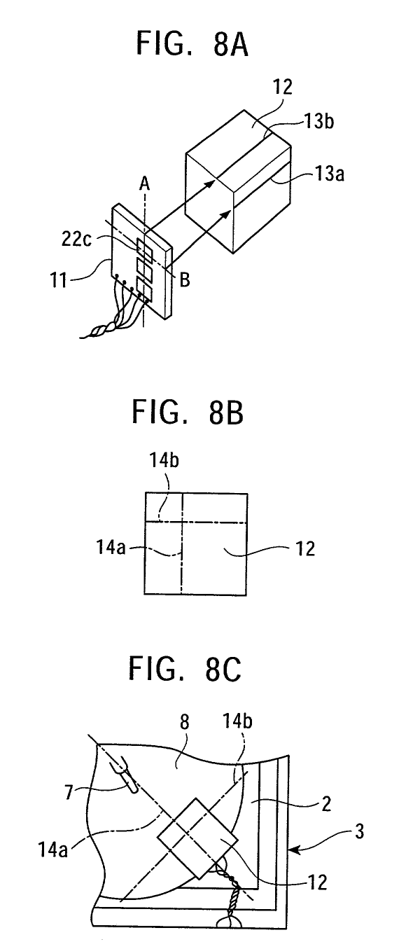

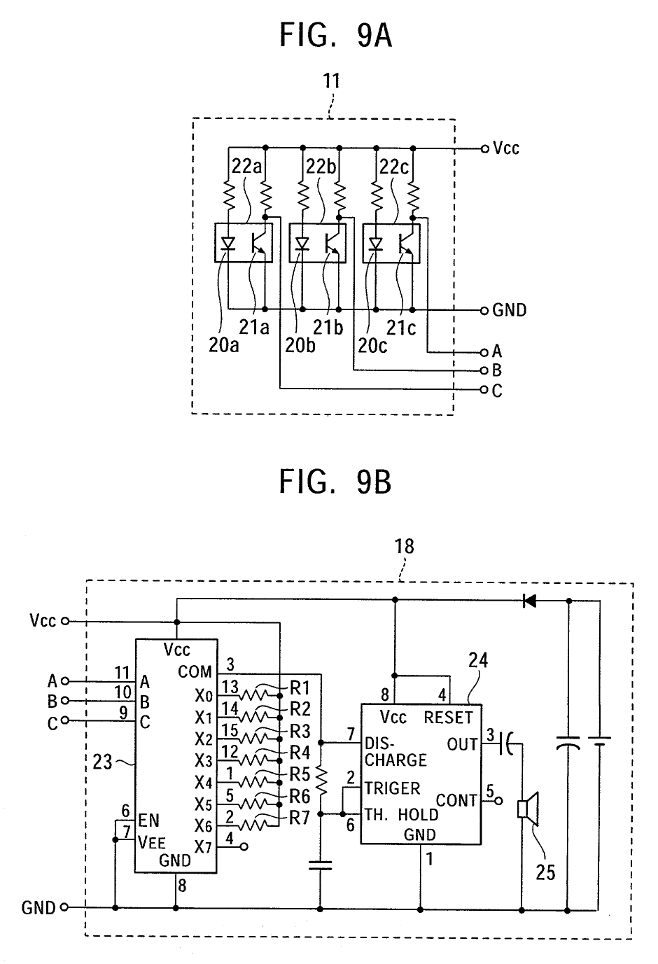

FIG. 8a to FIG. 8c concern the gist of the attachment of the sensor substrate 11 constituting the reproducing apparatus of FIG. 6. FIG. 8a is a perspective view showing the gist of the attachment of the sensor substrate 11 to the bottom end face of a spacer 12. FIG. 8b is the top view of the spacer 12, and shows the gist of the setting of the spacer 12 after the attachment of the sensor substrate 11 in a housing 3 of the reproducing apparatus by the fixation of the spacer 12 on the inner surface of the top plate constituting the housing 3. FIG. 8c is a plan view of the spacer 12 fixed on the inner surface of the top plate of the housing 3 in accordance with the gist of FIG. 8b when the top plate is looked at from above. FIG. 9a is an electric circuit diagram of the sensor substrate 11, and FIG. 9b is an electric circuit diagram of the main circuit board 18.

As shown in FIG. 6 and FIG. 7a to FIG. 7b, in order to give an impression that the learner is making the apparatus by his/her own hands, in the housing 3, a bottom plate 1 and a side plate 4a are formed as a first CD case, and a side plate 4b and a top plate 2 are formed as a second CD case. And further, a bearing 5 is inserted into a bearing hole 6 formed at the center of the bottom plate 1, and the bearing 5 is affixed to the bearing hole 6 with an adhesive.

Furthermore, a rotating shaft 7 is inserted into the central hole of the wooden rotor plate 8 having a diameter of 12 cm, which is the same size of an actual CD, with pressure, and a plate surface of the rotor plate 8 is set to contact with a positioning disc 10 that is formed in the shape of a flange on the rotating shaft 7. Then, the rotor plate 8 is positioned to form a right angle with the rotating shaft 7, and is fixed to the rotating shaft 7 with an adhesive. One end of the rotating shaft 7, to which the rotor plate 8 is fixed, is supported by the bearing 5 such that the rotating shaft 7 can freely rotate. Furthermore, the other end of the rotating shaft 7 is engaged with an opening 2a formed at the central position of the top plate 2 such that the rotating shaft 7 can freely rotate. In such a state, one of the side surfaces, which are opened, of the housing 3 is covered by the affixing of a side plate 4c made of cardboard with a tape.

Incidentally, if the aforesaid positioning disc 10 is formed in a shape being relatively long in the axial center direction of the rotating shaft 7, the positioning disc 10 can be used as a hold section for the sake of the learner's holding the positioning disc at the time of the assembling of the learning kit or the learning of the operation thereof.

Hereupon, a gist for the attachment of the sensor substrate 11 is described. As shown in FIG. 8a, an A-line that passes through the center of a sensor 22c positioned in the edge portion opposed to the leading edge portion of the lead wires of the sensor substrate 11 and forms a right angle to the edge portion and a B-line that passes through the center of the sensor 22c and forms a right angle to the A-line are supposed, and the sensor substrate 11 is glued to be fixed on the edge surface of the spacer 12 with a tape in such a way that the A-line accords with a reference line 13b of the spacer 12 and the B-line accords with the position of a reference line 13a of the spacer 12. Moreover, the sensor substrate 11 is attached in the housing 3 by the fixation of the spacer 12 to the inner surface of the top plate 2 by means of the adhesion of a tape in such a way that reference lines 14a and 14b formed on the other surface of the spacer 12, on one surface of which the sensor substrate 11 is fixed, as shown in FIG. 8b, accord with reference lines formed on the top plate 2 correspondingly. By the operations mentioned above, the spacer 12 after the attachment of the sensor substrate 11 is fixed on the inner surface of the top plate 2, i.e. is fixed in the housing 3, as shown in FIG. 8c. And then, the main circuit board 18 is fixed on the external surface of the side plate 4b adjoining the top plate 2 with the adhesion of a tape.

Next, the electric circuits of the sensor substrate 11 and the main circuit board 18 are described. As shown in FIG. 9a, the sensor substrate 11 is provided with a sensor 22a composed of a light emitting diode 20a and a phototransistor 21a, a sensor 22b composed of a light emitting diode 20b and a phototransistor 21b, and a sensor 22c composed of a light emitting diode 20c and a phototransistor 21c.

Furthermore, as shown in FIG. 9b, the main circuit board 18 is provided with a frequency setting circuit 23, resistors R1-R7, an output circuit 24, a speaker 25, and other devices. That is, the frequency setting circuit 23 is provided with the resistor R1, the value of the resistance of which is 24 kΩ, a resistor R2, the value of the resistance of which is 43 kΩ, a resistor R3, the value of the resistance of which is 68 kΩ, a resistor R4, the value of the resistance of which is 100 kΩ, a resistor R5, the value of the resistance of which is 110 kΩ, a resistor R6, the value of the resistance of which is 150 kΩ, and the resistor R7, the value of the resistance of which is 180 kΩ.

The resistor R1 is a circuit element of a setting circuit for the frequency of 831 Hz in correspondence with a “si tone”. The resistor R2 is a circuit element of a setting circuit for the frequency of 740 Hz in correspondence with a “la tone”. The resistor R3 is a circuit element of a setting circuit for the frequency of 659 Hz in correspondence with a “sol tone”. Similarly, the resistor R4 is a circuit element of a setting circuit for the frequency of 587 Hz in correspondence with a “fa tone”. The resistor R5 is a circuit element of a setting circuit for the frequency of 554 Hz in correspondence with a “mi tone”. The resistor R6 is a circuit element of a setting circuit for the frequency of 494 Hz in correspondence with a “re tone”. The resistor R7 is a circuit element of a setting circuit for the frequency of 440 Hz in correspondence with a “do tone”.

Next, a description is given to a method for reproducing the information recorded on the optical disc 15 with the aforesaid reproducing apparatus as a sound signal. The top plate 2 of the housing 3 is opened. The optical disc 15 is placed on the rotor plate 8. The upper end portion of the rotating shaft 7 (the upward projecting portion thereof from the top plate 2) is rotated by the fingers of a learner in a state of being pinched by the fingers to rotate the rotor plate 8 counterclockwise as shown in FIG. 7b (when the rotor plate 8 is looked at from the information recording surface side of the optical disc 15). Thereby, scale codes coded at every unit code setting region of the optical disc 15 are optically detected in sequence by the sensor substrate 11. Then, tones of the frequencies decoded corresponding to the scale codes are output from the speaker 25 of the main circuit board 18.

In this case, the sensors 22a, 22b and 22c respectively detect the codes in the unit code regions 17(a1)-17(a72) of the code setting band section B1, the unit code regions 17(b1)-17(b72) of the code setting band section B2 and the unit code regions 17(c1)-17(c72) of the code setting band section B3.

That is, by the counterclockwise rotation of the rotor plate 8, at first, a first unit code setting region composed of the unit code regions 17(a1), 17(b1) and 17(c1) is disposed at a detection position for the performance of the detection of the codes. Alight beam is irradiated in the unit code region 17(a1) from the light emitting diode 20a of the sensor 22a, and a reflected light beam from the unit code region 17(a1) in white color is detected by the phototransistor 21a. Then, a detection signal of the logical value of “1” after the photoelectric conversion by the phototransistor 21a is output from the phototransistor 21a. Moreover, a light beam from the light emitting diode 20b of the sensor 22b is not reflected from the unit code region 17(b1) in black color. Then, the logical value of the detection signal of the phototransistor 21b is “0”. Similarly, the logical value of the detection signal of the phototransistor 21c of the sensor 22c is also “0”.

When the code that is a coded “do tone” of the frequency of 440 Hz and is made in the first unit code setting region constituted of the unit code regions 17(a1), 17(b1) and 17(c1) is detected by the sensor substrate 11 in the way as mentioned above, an electric current flows through the resistor R7, and a corresponding drive signal is output from the output circuit 24. Then, a “do tone” of the frequency of 440 Hz is output from the speaker 25 by the drive signal.

In a similar way, tones of the scale of one octave are successively output from the speaker 25 of the main circuit board 18 like a “re tone”, a “mi tone”, . . . , and a “si tone” with the rotation of the rotor plate 8.

As mentioned above, the present example basically enables a learner to learn the fundamental structure of a CD player in the process of assembling the model of the CD player from a set of materials, and to learn the operation principles of the CD player in which the optical disc 15 on which a piece of music has already been recorded after being coded into codes is placed on the rotor plate 8 to be rotated and then the coded codes are read by the sensor substrate 11 and the main circuit board 18 to be decoded for the output of tones having corresponding frequencies from the speaker 25.

Furthermore, the meaning of binary numerals and the principles of coding can be learnt as follows. The unit code regions selected at every unit code setting region of a plurality of code setting band sections B1, B2 and B3 on the optical disc 15 are coated out in black on the basis of tones having different frequencies of a scale. Then, white color and black color are respectively supposed to be binary signals of the logical values of “1” and “0”, and the coding of the combination of the binary signals is performed.

Incidentally, the present invention is not limited to the aforesaid examples. In place of the making of optical code information using white color and black color on the optical disc 15, it is also possible to make magnetic code information according to the existence of magnetization on the disc 15a of FIG. 1. Moreover, four code setting band sections or more can be made on the disc 15a, and the unit angle of the division of code setting band sections into unit code regions can also be 50 or less.

Furthermore, by the division of the disc 15a into to parts at a diameter, the placement of the disc 15 on the rotor plate 8 can easily be performed. Further, the attachment of the spacer 12 to which the sensor substrate 11 is fixed to the housing 3 may be performed by the engagement of fixed projections. Moreover, the spacer 12 may be structured in which the spacer 12 is attached by three-dimensional adjustment of the position thereof to the rotor plate 8.

On the other hand, the rotor plate 8 can be driven by the rotation of a motor by the formation of a hooking groove for hooking a rubber belt on the side face of the rotor plate 8 and by the driving of the rubber belt hooked in the hooking groove with the motor. Moreover, the rotor plate 8 can also be rotated by wind force by the provision of an attachment section of a windmill on the rotating shaft 7.

Finally, the configurations and structures of respective units and portions described specifically with respect to the preferred embodiments of the present invention are only examples of realization of the present invention, so the embodiments thereof should not be construed as to limiting the technical scope of the present invention and any of the embodiments may be combined as well.

What is claimed is:

1. An disc having code setting regions where code information is set by selective coloring according to information to be recorded on prescribed portions of said disc, said code information being represented by coloring pattern, that can be optically read, in said code setting regions.

2. The disc according to claim 1, wherein said code setting regions are formed by unitization of code setting band sections continuously arrayed along a circumferential direction of said disc by dividing said code setting band sections at every prescribed angle around a center of said disc.

3. The disc according to claim 2, wherein said code setting band sections are made as a plurality of concentric circles, and the code information is represented by the code setting regions positioned in parallel to each other in a radial direction as a unit.

4. The disc according to claim 1, wherein color of a surface of the disc is a light-reflecting color, and said code setting regions are selectively colored with painting of color decreasing the reflection of the light of the surface of the disc to set the code information.

5. The disc according to claim 4, wherein the paint of color decreasing a reflection coefficient of the surface of the disc is a paint of black color.

6. The disc according to claim 1, wherein color of a surface of the disc is color decreasing reflection of light, and said code setting regions are selectively colored with a paint having a reflection coefficient higher than that of the surface of the disc to set the code information.

7. The disc according to claim 6, wherein the paint having the reflection coefficient higher than that of the surface of the disc is white color paint.

8. A kit comprising an disc having code setting regions where code information is represented by selective coloring according to information to be recorded on prescribed portions of said disc, wherein said code information is represented by coloring pattern in said code setting regions, that can be optically read.

9. The kit according to claim 8, wherein said code setting regions are formed by unitization of code setting band sections continuously arrayed along a circumferential direction of the disc by division of the code setting band sections at every prescribed angle around a center of the disc.

10. The kit according to claim 9, wherein said code setting band sections are made as a plurality of concentric circles, and the code information is represented by the code setting regions positioned in parallel to each other in a radial direction as a unit.

11. The kit according to claim 8, wherein color of a surface of the disc is a light-reflecting color, and said code setting regions are selectively colored with a paint of color decreasing the reflection of the light of the surface of the disc to set the code information.

12. The kit according to claim 11, wherein the paint of the color decreasing a reflection coefficient of the surface of the disc is a paint of black color.

13. The kit according to claim 8, wherein color of a surface of the disc is color decreasing reflection of light, and said code setting regions are selectively colored with a paint having a reflection coefficient higher than that of the surface of the disc to set the code information.

14. The kit according to claim 13, wherein the paint having the reflection coefficient higher than that of the surface of the disc is white color paint.

15. The kit according to claim 8, wherein said kit is configured such that a housing is removably provided with a rotor plate for rotating said disc in a state of placing said disc thereon, a sensor section for detecting the code information of said disc optically, and an output section for outputting a sound signal on a basis of a detection signal form the sensor section.

16. The kit according to claim 15, wherein all of or a part of a top plate, a bottom plate and side plates of the housing are freely disassembled and assembled.

17. A disc having code setting regions where code information is represented by selective magnetization according to information to be recorded on prescribed portions of the disc, wherein said code information is magnetically read according to existence of the magnetization of said code setting regions.

18. The disc according to claim 17, wherein said code setting regions are formed by unitization of code setting band sections arrayed continuously along a circumferential direction of the disc by division of the code setting band sections at every prescribed angle around a center of the disc.

19. The disc according to claim 18, wherein said code setting band sections are made as a plurality of concentric circles, and the code information is represented by the code setting regions positioned in parallel to each other in a radial direction as a unit.

20. The disc according to claim 17, wherein a surface of the disc is formed with a non-magnetic material, and the code information is made by selective magnetization of the code setting regions with a magnetic material.

21. The disc according to claim 20, wherein the code information is made by selective affixing of a magnetic sheet in said code setting regions.

22. A kit including a disc having code setting regions where code information is represented by selective magnetization according to information to be recorded on prescribed portions of the disc, wherein said code information is magnetically read according to existence of the magnetization of said code setting regions.

23. The kit according to claim 22, wherein said code setting regions are formed by unitization of code setting band sections arrayed continuously along a circumferential direction of the disc by division of the code setting band sections at every prescribed angle around a center of the disc.

24. The kit according to claim 23, wherein said code setting band sections are made as a plurality of concentric circles, and the code information is represented by the code setting regions positioned in parallel to each other in a radial direction as a unit.

25. The kit according to claim 22, wherein a surface of the disc is formed with a non-magnetic material, and the code information is represented by selective magnetization of the code setting regions with a magnetic material.

26. The kit according to claim 25, wherein the code information is represented by selectively affixing of a magnetic sheet in said code setting regions.

27. The kit according to claim 22, wherein said kit is configured such that a housing is removably provided with a rotor plate for rotating said magnetic disc in a state of placing said disc thereon, a sensor section for detecting the code information of said disc magnetically, and an output section for outputting a sound signal on a basis of a detection signal form the sensor section.

28. The kit according to claim 27, wherein all of or a part of a top plate, a bottom plate and side plates of the housing are freely disassembled and assembled.
